(19) United States
(12) Patent Application Publication
(10) Pub. No.: US 2016/0074974 A1
(43) Pub. Date: Mar. 17, 2016

(54) PROCESS FOR THE RECOVERY OF MOULDS FOR THE MANUFACTURING OF GLASS PARTS AND CONTAINERS

(71) Applicant: CONSTRUCCIONES Y REPARACIONES MECÁNICAS SIVÓ, S.L., Caudete (ES)

(72) Inventor: José SIVÓ ROMERO, Caudete (ES)

(21) Appl. No.: 14/785,983

(22) PCT Filed: Apr. 16, 2014
(86) PCT No.: PCT/IB2014/060764

§ 371 Date: Oct. 21, 2015

(30) Foreign Application Priority Data
Apr. 29, 2013 (ES) P201330620

(51) Int. Cl. B23P 6/00; C03B 9/48

(52) U.S. Cl. CPC B23P 6/00; C03B 9/48

(57) ABSTRACT

Process for the recovery of moulds (1) for the manufacturing of glass parts and containers, comprising the following stages: a)cleaning the layer of deteriorated material (2a) of the moulding surface (2) by a machining process which makes it possible to remove said layer (2a) copying a template of the part to be produced, to thus obtain a surface layer of material clean of impurities; and b)filling with welding and machining the external surfaces (3) for securing the mould (1) to the pouring or injection machine, to recover the original measurements of the mould (1). It achieves a simple and effective process which makes it possible to considerably lengthen the useful life of said moulds.

The present invention relates to a process for the recovery of moulds for the manufacturing of glass parts and containers.

### BACKGROUND OF THE INVENTION

The known moulds for the manufacturing of glass parts and containers are of cast iron with a graphite-rich specific alloy or a bronze alloy to facilitate demoulding. Due to the prolonged use of said moulds, the surface layer which defines the template with the form of the part to be produced deteriorates so that the mould is no longer useful.

Before the end of the useful life of the mould there is the possibility of repairing it with the purpose of continuing to work with said mould during a certain additional time. However, the number of repairs that the mould allows is limited and once the mould can no longer be repaired it is considered that its useful life has finished and, in consequence, it is discarded.

Currently the manufacturing of moulds for glass parts and containers is programmed for a certain useful life, bearing in mind the material and the quantity of parts that can be cast with that mould. Due to this, when the life of the mould comes to an end it is discarded and a new mould is manufactured to continue with the production.

The main problem of reusing the mould is the loss of properties of the material due to fatigue from working at a temperature, so that the mould would not be useful even if repaired.

Therefore, the need for a mould recovery process, which allows its useful life to be extended, is evident.

### DESCRIPTION OF THE INVENTION

The objective of the process for the recovery of moulds for the manufacturing of glass parts and containers of the present invention is to resolve the drawbacks of the processes known in the state of the art, providing a simple and effective method which makes it possible to considerably lengthen the useful life of said moulds.

The process for the recovery of moulds for the manufacturing of glass parts and containers, object of the present invention, is of the type wherein said mould comprises a moulding surface defined by a template with the form of the part to be produced, and external surfaces provided for the securing of the mould to a pouring or injection machine of the glass material to be moulded, and the material of the moulding surface being deteriorated by the continued use of the mould. The process is characterized in that it comprises the following stages:
a) cleaning the layer of deteriorated material of the moulding surface by a machining process which makes it possible to remove said layer copying a template of the part to be produced, to thus obtain a surface layer of material clean of impurities; and
b) filling with welding and machining the external surfaces for securing the mould to the pouring or injection machine, to recover the original measurements of the mould.

Thanks to the process of the invention the life of the mould is substantially lengthened to continue with the production, thus obtaining a significant reduction in costs.

This removal operation of the layer of deteriorated material makes it possible to clean the surface material in permanent contact with the glass material which is being cast, and thus regenerate the properties of the material of the mould which becomes clean from impurities in this surface area.

Preferably, during stage a) the deteriorated layer is removed copying the original template of the part to be produced, or optionally a template other than the original is copied and the incorporation of generic or customized engravings is even provided.

Advantageously, the machining process of stage a) is mainly performed by lathes, milling machines or any type of suitable machinery in accordance with the form of the template of the part to be produced.

Preferably, the removal depth of the deteriorated material to clean is between 0.1 mm and 3 mm.

Optionally, a surface hardening treatment of the mould is later performed.

Therefore, once the mould recovery process has been performed, it is possible to perform a thermal treatment or a coating of the surface layer of the mould, to thus achieve greater surface hardness further increasing, if possible, the useful life of the mould after this process.

### BRIEF DESCRIPTION OF THE DRAWINGS

For a better understanding of all that disclosed, drawings are attached wherein, diagrammatically and only as a non-limitative example, a practical embodiment is represented of the process for the recovery of moulds for the manufacturing of glass parts and containers of the invention, wherein:

FIG. 1 is an elevational view of a semi-part of the mould used, showing the template of the part to be moulded and the areas which must be repaired; and

FIG. 2 is a plan view of the closed mould.

### DESCRIPTION OF A PREFERRED EMBODIMENT

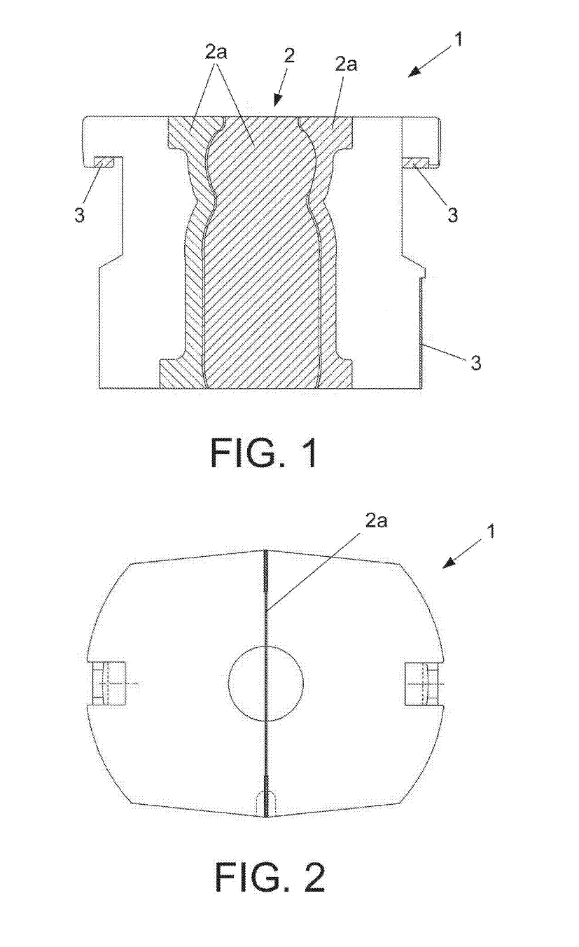

As can be observed in FIGS. 1 and 2, the type of mould 1 used for the manufacturing of glass parts and containers comprises a moulding surface 2 defined by a template with the form of the part to be produced, and external surfaces 3 provided for the securing of the mould 1 to a pouring or injection machine (not represented) of the glass material to be moulded. Due to continued use of the mould 1, the material of the moulding surface 2 deteriorates and needs to be repaired.

The process for the recovery of a mould 1 for the manufacturing of glass parts and containers, of the present invention, comprises the following stages:
cleaning the layer of deteriorated material 2a of the moulding surface 2 by a machining process which makes it possible to remove said layer 2a copying a template of the part to be produced, to thus obtain a surface layer of material clean of impurities; and
filling with welding and machining the external surfaces 3 for securing the mould 1 to the pouring or injection machine, to recover the original measurements of the mould 1.

Thanks to the process of the invention the life of the mould 1 is substantially lengthened to continue with the production, thus obtaining a significant reduction in costs.

This removal operation of the layer of deteriorated material 2a makes it possible to clean the surface material in permanent contact with the glass material which is being cast, and thus regenerate the properties of the material of the mould 1 which becomes clean from impurities in this surface area.

The machining process can be mainly performed using lathes, milling machines or any type of suitable machinery in accordance with the form of the template of the part to be produced.

The removal depth of the deteriorated material 2a to clean is between 0.1 mm and 3 mm, although it may be more or less depending on the requirements in each case.

A surface hardening treatment of the mould 1 can later be performed. In this case, once the mould recovery process has been performed 1, it is possible to perform a thermal treatment or a coating of the surface layer of the mould 1, to thus achieve greater surface hardness further increasing, if possible, the useful life of the mould 1 after this process.

It should be highlighted that the process of the invention could also be performed before the end of its useful life, if circumstances so required, for example, to copy to a different template or for any other necessary reason.

Despite the fact that reference has been made to a specific embodiment of the invention, it is evident for a person skilled in the art that numerous variations and modifications can be introduced in the process for the recovery of a mould for the manufacturing of glass parts and containers described, and that all the details mentioned can be replaced by other technically equivalent ones, without departing from the scope of protection defined by the attached claims.

1. A process for the recovery of moulds for the manufacturing of glass parts and containers, of the type wherein said mould comprises a moulding surface defined by a template with the form of the part to be produced, and external surfaces provided for the securing of the mould to a pouring or injection machine of the glass material to be moulded, and the material of the moulding surface being deteriorated by the continued use of the mould, wherein the process comprises the following steps:
cleaning a layer of the deteriorated material of the moulding surface by a machining process which makes it possible to remove the deteriorated material layer by copying a template of the part to be produced, to thus obtain a surface layer of material clean of impurities; and
filling with welding and machining the external surfaces for securing the mould to the pouring or injection machine, to recover the original measurements of the mould.

2. The process of claim 1, wherein during the cleaning step the deteriorated layer is removed copying the original template of the part to be produced, or optionally a template other than the original is copied and the incorporation of generic or customized engravings is even provided.

3. The process of claim 1, wherein the machining process is mainly performed by lathes, milling machines or any type of suitable machinery in accordance with the form of the template of the part to be produced.

4. The process of claim 1, wherein a removal depth of the deteriorated material layer to clean is from about 0.1 mm to about 3 mm.

5. The process of claim 1, wherein a surface hardening treatment of the mould is later performed.
